(19) United States
(12) Patent Application Publication
(10) Pub. No.: US 2026/0358855 A1
(43) Pub. Date: Nov. 12, 2026

(54) WORK QUALITY CONTROL METHOD, WORK QUALITY CONTROL SYSTEM, AND WORK QUALITY CONTROL DEVICE

(71) Applicant: HITACHI, LTD., Tokyo (JP)

(72) Inventors: Hiroyuki Yoshimoto, Tokyo (JP); Yu Yamada, Tokyo (JP)

(73) Assignee: HITACHI, LTD., Tokyo (JP)

(21) Appl. No.: 19/135,196

(22) PCT Filed: Nov. 27, 2023
(86) PCT No.: PCT/JP2023/042397

§ 371 Date: Jun. 3, 2025

(30) Foreign Application Priority Data
Dec. 13, 2022 (JP) 2022-198790

(51) Int. Cl. G06Q 10/0639; G06F 1/16

(52) U.S. Cl. CPC G06Q 10/06395; G06F 1/163

(57) ABSTRACT

A work quality control system manages work quality of a worker who performs work by the rotation of the rotation body included in the instrument. A work quality control method executed by the work quality control system includes: a signal processing step of digitizing a sound that is emitted from the instrument due to the rotation of the rotation body and that is detected by a microphone to generate a sensor signal; a detection step of detecting a resonant frequency peak derived from a resonant frequency sound from the sensor signal; an operation collation step of recognizing an operation period of the instrument based on the resonant frequency peak; a signal determination step of determining normality or abnormality of the work based on the resonant frequency peak in the operation period recognized in the operation collation step; a notification step of notifying a determination result in the signal determination step.

### TECHNICAL FIELD

The present invention relates to a work quality control method, a work quality control system, and a work quality control device.

### BACKGROUND ART

At an assembly site in a manufacturing industry or the like, the occurrence of a defective product is prevented in advance by improving work accuracy and creating a manufacturing defect, and the defective product is prevented from flowing to the outside by discarding the defective product by checking in an inspection step.

However, since the inspection step is located in the subsequent stage in the manufacturing process, it takes time to identify the cause of the manufacturing defect found in the inspection step, and a large number of man-hours are required for countermeasures against the manufacturing defect, which

Therefore, it is desirable to immediately take measures against the manufacturing defect when the manufacturing failure is found. In particular, since human errors in manual work are likely to cause the manufacturing defect, it is desirable to quickly give feedback on the human error to the worker.

Here, the manual work in the assembly site includes connection work of electric wirings by connectors, tightening work of screws or bolts, painting work, attachment work of components, and the like. As a technique for quickly finding human errors in manual work, PTL 1 discloses a system that checks whether workerers themselves have performed a connection confirmation operation of pulling a connector after the connection work of electric wirings by the connector in the connection work.

In addition, for example, PTL 2 discloses a system that detects insufficient tightening of a screw and detects abnormal tightening in which a screw is inserted in an oblique direction with respect to a cross section of a screw hole, based on a screw tightening torque detected by a torque detection function of an electric screwdriver.

In this way, it is possible to detect, based on a motor load of a built-in motor such as the electric screwdriver, an abnormality in work using an electric tool that transmits a rotational torque of the built-in motor to a work target.

### CITATION LIST

### Patent Literature

PTL 1: JP2021-001410A

PTL 2: JP2021-112784A

### SUMMARY OF INVENTION

### Technical Problem

However, the electric screwdriver is not always provided with the torque detection function as in the related art disclosed in PTL 2 described above, and the torque detection function is not provided in many cases for reasons such as cost and performance. It may be difficult to detect the motor load in an electric screwdriver not having the torque detection function.

The invention has been made in view of the background described above, and an object thereof is to perform abnormality detection of work using an instrument that does not have a function of directly detecting a physical quantity derived from rotation of a built-in rotation body.

### Solution to Problem

One aspect of the invention is a work quality control method executed by a work quality control system configured to manage work quality of a worker who performs work by rotation of a rotation body included in an instrument, the work quality control method including: a signal processing step of digitizing a sound that is emitted from the instrument due to the rotation of the rotation body and that is detected by a microphone and generating a sensor signal; a detection step of detecting a resonant frequency peak derived from a resonant frequency sound from the sensor signal; an operation collation step of recognizing an operation period of the instrument based on the detected resonant frequency peak; a signal determination step of determining normality or abnormality of the work based on the resonant frequency peak in the operation period recognized in the operation collation step; and a notification step of notifying a determination result in the signal determination step.

### Advantageous Effects of Invention

According to one aspect of the present application, abnormality detection of work using an instrument not having a function of directly detecting a physical quantity derived from rotation of an in-built rotation body can be performed.

### BRIEF DESCRIPTION OF DRAWINGS

FIG. 1 is a diagram illustrating an example of a configuration of a work quality control system according to Embodiment 1.

FIG. 2 is a diagram illustrating an example of a wearable sensor according to Embodiment 1.

FIG. 3 is a diagram illustrating an electric screwdriver.

FIG. 4 is a diagram illustrating a state in which the wearable sensor is attached and the electric screwdriver is gripped.

FIG. 5 is a diagram illustrating an example of a spectrogram in which an intensity of a sound per time obtained by performing frequency decomposition on a sound acquired via a microphone sensor, is indicated by shading on a vertical axis.

FIG. 6 is a diagram illustrating an example of a frequency distribution of sound per time obtained by performing the frequency decomposition on the sound acquired via the microphone sensor.

FIG. 7 is a diagram illustrating an example of a spectrogram indicating an abnormality in which a resonant frequency changes during work.

FIG. 8 is a diagram illustrating an example of a spectrogram indicating an abnormality in which the resonant frequency does not decrease at the end of work.

FIG. 9 is a flowchart illustrating work state determination processing according to Embodiment 1.

FIG. 10 is a diagram illustrating an example of a graph of down-sampled down-sampling signals according to Embodiment 2.

FIG. 11 is a diagram illustrating an example of a wearable sensor according to Embodiment 3.

FIG. 12 is a diagram illustrating a graph of a signal value of a pressure sensor that detects finger pressure generated when a worker grips an instrument.

FIG. 13 is a flowchart illustrating work state determination processing according to Embodiment 3.

FIG. 14 is a diagram illustrating an example of a configuration of a work quality control system according to Embodiment 4.

FIG. 15 is a diagram illustrating an example of a detection pattern registered in a pattern library.

FIG. 16 is a diagram illustrating an example of a setting screen of the detection pattern registered in the pattern library.

FIG. 17 is a flowchart illustrating registration processing of the detection pattern in the pattern library according to Embodiment 4.

FIG. 18 is a flowchart illustrating work state determination processing (real-time detection) according to Embodiment 5.

FIG. 19 is a diagram illustrating an example of a configuration of a work quality control system according to another embodiment.

FIG. 20 is a diagram illustrating an example of a hardware structure of a computer.

### DESCRIPTION OF EMBODIMENTS

Hereinafter, embodiments of a work quality control method, a work quality control system, and a work quality control device according to the disclosure of the present application will be described with reference to the drawings. The embodiments are examples for describing the present application including the drawings. In the embodiments, omission and simplification are appropriately made for clarification of the description. Unless otherwise specified, the components of the embodiments may be singular or plural. An embodiment of a combination of one embodiment and another embodiment is also included in the embodiments according to the present application.

The same or similar components are denoted by the same reference numerals, and the description thereof may be omitted, or only differences may be mainly described in the following embodiments and examples. When there are a plurality of the same or similar components, the same reference numerals may be assigned with different subscripts to make the description. When there is no need to distinguish the plurality of components, the description may be made by omitting the subscripts. The number of each component may be singular or plural unless otherwise specified.

In the embodiments, processing performed by executing a program may be described. The computer performs processing defined by the program by a processor (such as a central processing unit (CPU) or a graphics processing unit (GPU) ) while using a memory of a main storage device. Therefore, a subject of the processing performed by executing the program may be the processor. A functional unit that performs processing is implemented by the processor executing the program.

Similarly, the subject of the processing executed by executing the program may be a controller, a device, a system, a computer, or a node including the processor. The subject of the processing performed by executing the program may be a calculation unit and may include a dedicated circuit that executes specific processing. The dedicated circuit may be, for example, a field programmable gate array (FPGA) or an application specific integrated circuit (ASIC).

The program may be installed on the computer from a program source. The program source may be, for example, a program distribution server or a computer-readable non-transitory storage medium. When the program source is the program distribution server, the program distribution server may include a processor and a storage resource (storage) for storing a program to be distributed, and the processor of the program distribution server may distribute the program to be distributed to another computer. In the embodiments, two or more programs may be implemented as one program, or one program may be implemented as two or more programs.

### Embodiment 1

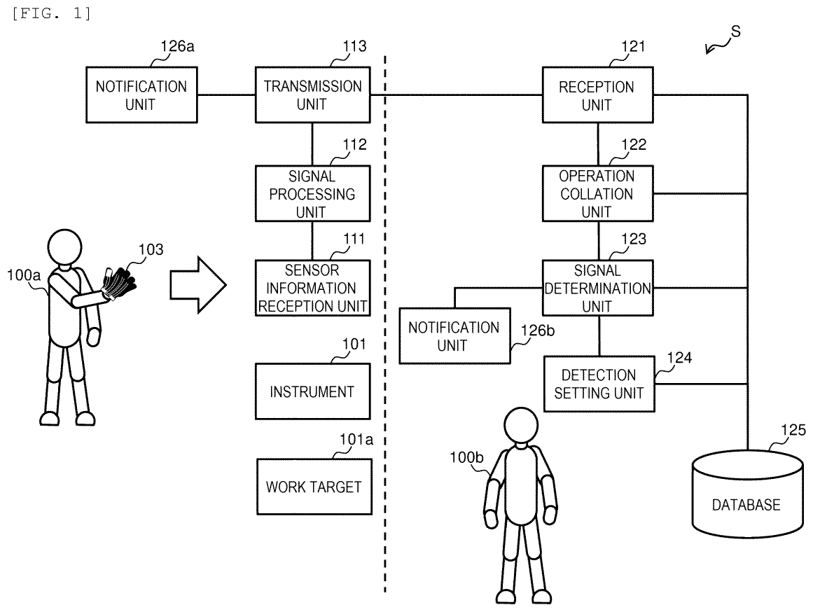

A work quality control system S according to Embodiment 1 will be described with reference to FIGS. 1 to 9.

FIG. 1 is a diagram illustrating an example of a configuration of the work quality control system S according to Embodiment 1. A worker 100a performs work on a work target 101a by using an instrument 101 including an internal rotation body. At this time, in the work quality control system S, a wearable sensor 103 worn by the worker 100a detects sensor information including a work sound derived from a rotational motion of the internal rotation body of the instrument 101.

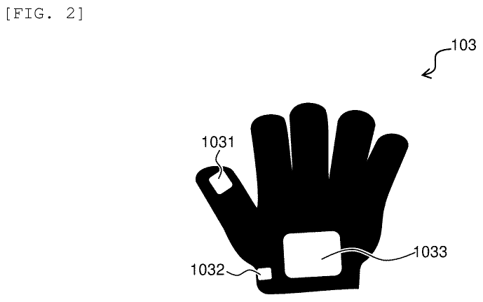

FIG. 2 is a diagram illustrating an example of the wearable sensor 103. As illustrated in FIG. 2, the wearable sensor 103 is a glove for work to be worn by the worker 100a. The wearable sensor 103 includes, for example, two microphone sensors 1031 and 1032 built-in at portions including a fingertip and wrist of the glove for collecting surrounding sounds.

The microphone sensor 1031 is located closer to the instrument 101 when the worker 100a wears the wearable sensor 103 and grips the instrument 101, and collects an operation sound of the instrument 101. The microphone sensor 1032 collects, for example, an operation sound of the instrument 101 of another worker 100a who is nearby. The sound collected by the microphone sensor 1032 is filtered and removed as noise from the sound collected by the microphone sensor 1031.

The wearable sensor 103 may include a built-in wireless transmitter 1033 that transmits the sensor information to a sensor information reception unit 111. The wearable sensor 103 may include a built-in sensor, such as an inertial sensor, that can acquire information that can be used for specifying an operation of the worker 100a by an operation collation unit 122. The wearable sensor 103 is not limited to a glove type and may be another type such as a glasses type or a wristwatch type.

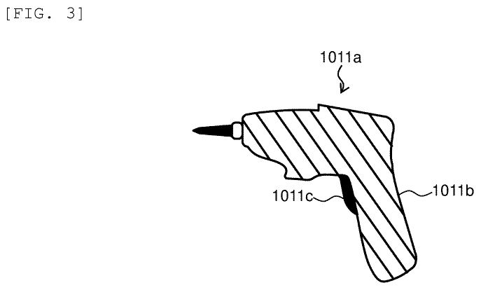

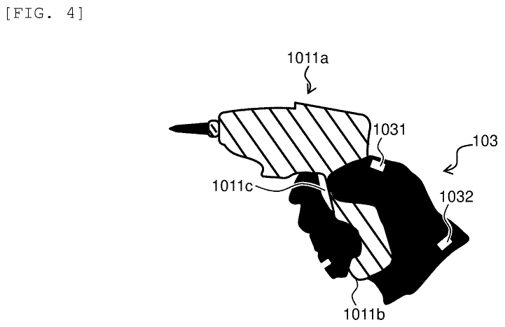

FIG. 3 is a diagram illustrating an example of an electric screwdriver 1011a. FIG. 4 is a diagram illustrating a state in which the wearable sensor 103 is attached and the electric screwdriver 1011a is gripped.

The electric screwdriver 1011a illustrated in FIG. 3 is an example of the instrument 101. As illustrated in FIG. 4, the worker 100a wears the wearable sensor 103 on a hand, grips a grip 1011b of the electric screwdriver 1011a, and grips and operates a switch 1011c during screw tightening work. By gripping and operating the switch 1011c, an internal rotation body of the electric screwdriver 1011a is rotated and stopped.

The instrument 101 is not limited to the electric screwdriver 1011a and may be an air screwdriver driven by compressed air that is not electrically driven. The instrument 101 may be an electric drill for drilling holes at fixing locations. The instrument 101 may also be a router, which is an instrument for polishing a surface of metal or the like. The internal rotation body included in the instrument 101 is, for example, a motor. The rotation body included in the instrument 101 may be a tip of a rotating screw of an air screwdriver. The rotation body included in the instrument 101 may be an internal gear or a mechanical driving portion.

Returning to the description of FIG. 1. The work quality control system S includes the sensor information reception unit 111, a signal processing unit 112, a transmission unit 113, a reception unit 121, the operation collation unit 122, a signal determination unit 123, a detection setting unit 124, a database 125, and notification units 126a and 126b.

The sensor information reception unit 111, the signal processing unit 112, the transmission unit 113, and the notification unit 126a are devices on a side of a work site of the worker 100a. The reception unit 121, the operation collation unit 122, the signal determination unit 123, the detection setting unit 124, the database 125, and the notification unit 126b are devices on a management side of an administrator 100b who manages a work quality of the worker 100a by using the work quality control system S.

The sensor information reception unit 111 acquires the sensor information on the sound detected by the microphone sensors 1031 and 1032 of the wearable sensor 103 via wireless communication (or wired communication). The signal processing unit 112 digitizes the analog sensor information, such as a sensor current value and an electric resistance acquired by the sensor information reception unit 111 to generate a sensor signal. The signal processing unit 112 generates, based on the sensor information on the microphone sensors 1031 and 1032, the sensor signal from which noise is removed.

The transmission unit 113 transmits the sensor signal generated by the signal processing unit 112 to the reception unit 121 via wireless communication (or wired communication).

The reception unit 121 receives the sensor signal transmitted by the transmission unit 113 and stores the sensor signal in a buffer (not illustrated) (in the case of real-time processing to be described later) or accumulates the sensor signal in the database 125 (in the case of offline processing to be described later).

Based on the sensor signal read from the buffer (not illustrated) or the database 125, the operation collation unit 122 specifies an operation period of the instrument 101 including the start and the end of the rotation of the internal rotation body of the instrument 101 performed by the worker 100a and specifies an operation signal in the operation period.

The signal determination unit 123 determines whether an operation of the instrument 101 is normal or abnormal (whether the work of the worker 100a using the instrument 101 is normal or abnormal) based on the operation signal specified by the operation collation unit 122.

The detection setting unit 124 performs a setting of a setting value serving as a reference when the operation collation unit 122 specifies the operation period and the operation signal of the instrument 101. The detection setting unit 124 performs a setting of a setting value serving as a reference for determining whether the operation of the instrument 101 is normal or abnormal based on the operation sound of the instrument 101 by the signal determination unit 123. The setting values set by the detection setting unit 124 may be stored in the database 125 or may be input by the administrator 100b via an input device (not illustrated).

The database 125 stores the sensor signal received via the reception unit 121 as work data. The database 125 also stores a determination result of the signal determination unit 123 as to whether the operation of the instrument 101 is normal or abnormal.

The notification unit 126a notifies the worker 100a of the determination result of the signal determination unit 123 as to whether the operation of the instrument 101 is normal or abnormal. The notification unit 126b notifies the administrator 100b of the determination result of the signal determination unit 123 as to whether the operation of the instrument 101 is normal or abnormal. The notification units 126a and 126b may perform the notification in a visually appealing manner by including a display screen, or may perform the notification by audio or vibration by including a speaker.

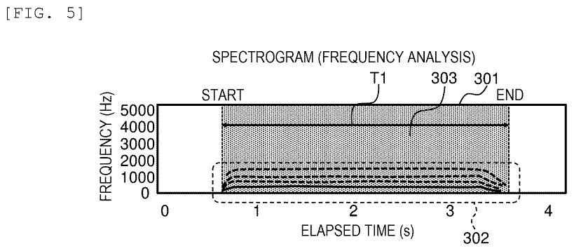

Next, signal processing of the operation collation unit 122 and the signal determination unit 123 on the sensor signal obtained by digitally converting the sensor information acquired by the wearable sensor 103 will be described with reference to FIGS. 5 to 8.

FIG. 5 is a diagram illustrating an example of a spectrogram in which an intensity of a sound per time obtained by performing frequency decomposition on a sound acquired via the microphone sensor 1031, is indicated by shading on a vertical axis. In FIG. 5, the sound generated according to the operation of the internal rotation body of the instrument 101 to be processed by the operation collation unit 122 is frequency-decomposed for each time point, and is indicated by a spectrogram 301 indicating signal intensity display per angular frequency with a color density of a graph.

When the operation of the instrument 101 gripped by the worker 100a is started, a resonant frequency sound and a harmonic resonant sound of a resonant frequency are generated, which are determined by physical characteristics of the instrument 101 including the internal rotation body and physical characteristics of the work target 101a with which the instrument 101 comes into contact. In FIG. 5, a resonant frequency peak 302 derived from a resonant sound includes the resonant frequency sound indicated by a solid line and the harmonic sound of the resonant frequency indicated by a broken line. A high-frequency sound exceeding the harmonic resonant sound of a resonant frequency is a harmonic noise sound 303.

The resonant frequency is, for example, about 500 Hz to 5 kHz. The operation collation unit 122 extracts a time T1 from the generation to the end of the resonant frequency by the signal processing, thereby specifying the operation and the start and end of the work of the instrument 101.

When the instrument 101 gripped by the worker 100a starts to operate, a work sound is generated according to a rotating operation of the internal rotation body. As indicated by hatching in a background of FIG. 5, the work sound includes not only a background noise sound ranging from a low frequency of about several hundred Hz to a high frequency region exceeding 5 kHz but also a sound having a certain fixed frequency such as a certain resonant frequency peak 302.

For example, when the electric screwdriver 1011a is taken as an example of the instrument 101, a sound having a unique frequency co-occurring with rotation of an internal motor of the electric screwdriver 1011a is generated with the start of work. A vibration frequency is determined by a plurality of factors such as an internal structure or a housing structure of the electric screwdriver 1011a such as rotation of the rotor and contact with a bearing of the motor, presence or absence of gripping of the electric screwdriver 1011a by the worker 100a, and contact with the work target 101a such as a screw or a screw hole. A frequency at which the resonant frequency sound is generated is generally accompanied by harmonics having frequencies that are integer multiples of a fundamental wave.

Such a work sound having a specific frequency generated from the instrument 101 including the internal rotation body is similarly generated by any worker 100a. Therefore, the work sound can be specified based on the characteristics including the resonant frequency sound and harmonics thereof. By specifying the work sound, it is possible to specify the start and end of the work and determine whether the work is normal or abnormal, which are associated with the work content such as what kind of work in which step.

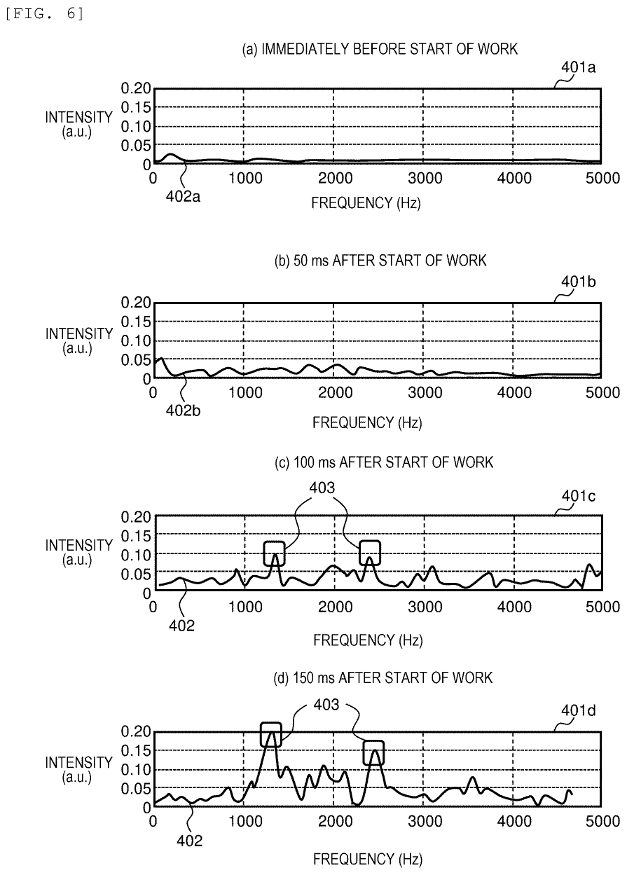

FIG. 6 is a diagram illustrating an example of a frequency distribution of sound per time obtained by performing the frequency decomposition on the sound acquired via the microphone sensor 1031. FIG. 6 illustrates a frequency distribution 401 of the sound acquired per time in the spectrogram 301 in FIG. 5.

(a) of FIG. 6 illustrates a frequency distribution 401a of the acquired sound before the work is started. In the case of (a) of FIG. 6, the work sound is not generated, and only an external noise sound 402a is detected at less than 1 KHz.

(b) of FIG. 6 illustrates a frequency distribution 401b of the acquired sound after 50 ms from the start of the work. In (b) of FIG. 6, a generated sound 402b generated due to the rotation of the internal rotation body of the instrument 101 is detected up to 5 kHz.

(c) of FIG. 6 illustrates a frequency distribution 401c of the acquired sound after 100 ms from the start of the work. In the case of (c) of FIG. 6, one or a plurality of peaks 403 derived from the resonant frequency sound 402 are detected on the resonant frequency sound 402.

(d) of FIG. 6 illustrates a frequency distribution 401d of the acquired sound after 150 ms from the start of the work. In the case of (d) of FIG. 6, one or the plurality of peaks 403 derived from the resonant frequency sound 402 are detected on the resonant frequency sound 402. The resonant frequency sound 402 that starts to be detected at 100 ms after the start of the work illustrated in (c) of FIG. 6 continues to appear as illustrated in (d) of FIG. 6 while the rotation body of the instrument 101 continues to operate. Therefore, by detecting the peaks 403, the start and continuation of the work can be determined, and when the peaks 403 finally disappear, the end of the work can be determined.

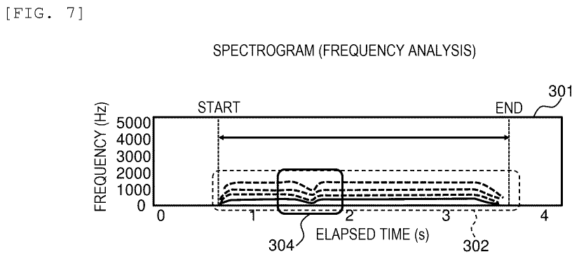

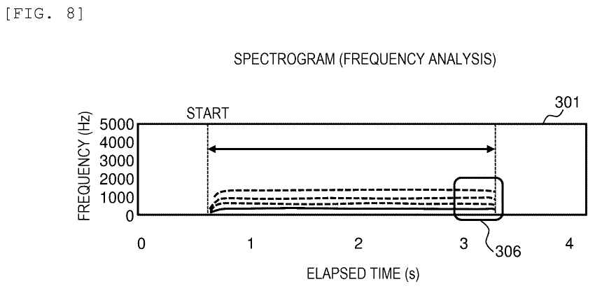

Next, a method for determining whether the work is normal or abnormal by the signal determination unit 123 will be described with reference to FIGS. 7 and 8. FIG. 7 is a diagram illustrating an example of a spectrogram indicating an abnormality in which the resonant frequency changes during work. FIG. 8 is a diagram illustrating an example of a spectrogram indicating an abnormality in which the resonant frequency does not decrease at the end of work.

The resonant frequency has a constant frequency value when the instrument 101 and the work target 101a are the same. However, for example, in screw tightening work of the electric screwdriver 1011a, if there is an abnormality such as a screw is attached obliquely to an attachment hole, an abnormal torque is applied to the electric screwdriver 1011a, a rotation speed of the motor which is the internal rotation body changes, and the resonant frequency also fluctuates accordingly. This is illustrated in FIG. 7.

A modulation abnormality 304 of the resonant frequency peak 302 illustrated in FIG. 7 occurs due to the above-described abnormality such as the screw being obliquely attached to the attachment hole. The signal determination unit 123 determines an abnormality based on, for example, the modulation abnormality 304. The modulation abnormality 304 of the resonant frequency peak 302 is determined using a fluctuation of, for example, 20% or more from the resonant frequency peak 302 (normal value) before modulation as a reference. The modulation abnormality 304 of the resonant frequency peak 302 may be a temporary fluctuation occurring between the start and the end of the work as illustrated in FIG. 7, or may be a continuous fluctuation occurring due to a mistake in the screw or a mistake in the workplace at the time of screw tightening.

Another modulation abnormality 305 of the resonant frequency peak 302 will be described with reference to FIG. 8. For example, in the screw tightening work, a high torque is applied to the electric screwdriver 1011a and the rotation speed of the motor decreases at the end of normal screw tightening. Therefore, as illustrated in FIG. 5, it is a waveform in which the resonant frequency gradually decreases.

In contrast, when if the work ends abnormally in a state in which the screw is insufficiently tightened, as illustrated in FIG. 8, the resonant frequency does not decrease, and a work end abnormality 306 of the resonant frequency occurs. In such a case, there is a risk that the screw is not sufficiently tightened and comes off after the product is shipped. The signal determination unit 123 may determine the modulation abnormality 305 of the resonant frequency peak 302 before such work normally ends. Alternatively, the abnormality determination may be performed based on a work time such as whether the work time from the work start to the work end is longer or shorter than a reference.

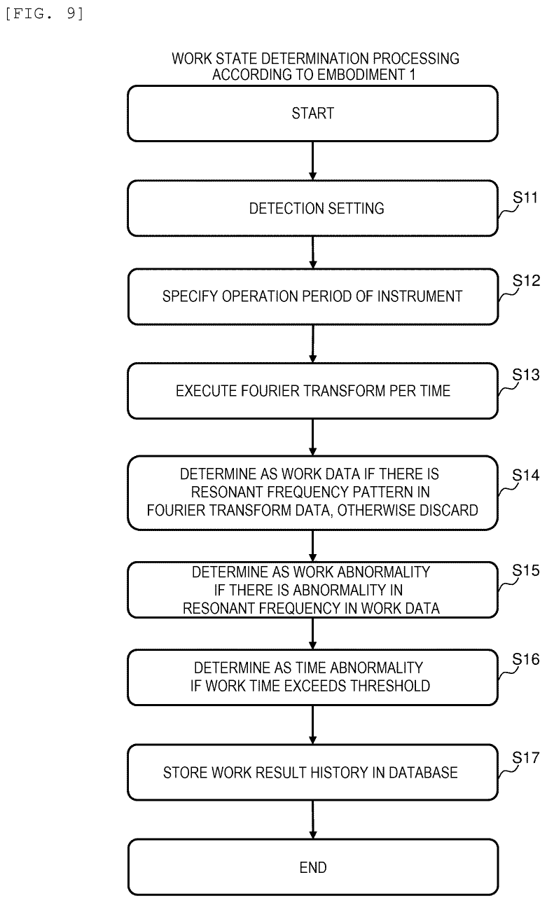

Next, work state determination processing executed by the work quality control system S according to Embodiment 1 will be described with reference to FIG. 9. FIG. 9 is a flowchart illustrating the work state determination processing according to Embodiment 1.

The work state determination processing may be real-time processing executed, after storing the sensor signal obtained by digitally converting the sensor information obtained from the wearable sensor 103 in a buffer (not illustrated), based on the sensor signal acquired from the buffer with a delay of, for example, 5 seconds. The work state determination processing may be offline processing executed, after storing the sensor signal obtained by digitally converting the sensor information acquired from the wearable sensor 103 in the database 125, based on the stored sensor signal acquired from the database 125.

First, in step S11, the detection setting unit 124 performs a setting of various setting values such as the setting value serving as a reference when specifying the operation signal of the instrument 101 and the setting value serving as a reference for determining whether the work of the worker 100a is normal or abnormal based on the operation sound of the instrument 101. The various setting values are set for each work that can be specified by a combination of the instrument 101 and the work target 101a. The detection setting in step S11 is omitted in the second and subsequent processing using the same various setting values, regardless of whether the work state determination processing is real-time processing or offline processing.

Next, in step S12, the operation collation unit 122 recognizes the operation of the instrument 101 based on the acquired sensor signal. Specifically, the operation collation unit 122 specifies the operation signal indicating the operation period including the start and end of the rotation of the internal rotation body of the instrument 101 performed by the worker 100a. The operation signal is specified based on, for example, a resonant frequency peak extracted from a frequency spectrum of the operation sound of the instrument 101 or a resonant frequency peak extracted by specifying a frequency.

Next, in step S13, the operation collation unit 122 performs frequency analysis per time such as Fourier transform processing on the operation signal specified in step S12.

In the next step S14, the operation collation unit 122 determines whether the resonant frequency peak 302 appears in the data after the Fourier transform in step S13. The operation collation unit 122 discards data in which the resonant frequency peak 302 does not appear as an obstacle excluded from the determination target and cancels the subsequent processing.

Next, in step S15, the signal determination unit 123 determines whether the resonant frequency peak 302 is normal or abnormal from the viewpoint illustrated in FIGS. 7 and 8. Next, in step S16, the signal determination unit 123 determines an abnormality in which the work time (operation time) is longer or shorter than a prescribed value by a certain amount or more. Finally, in step S17, the signal determination unit 123 stores a work state determination history that is a determination result of step S15 or S16 in the database 125. In step S17, when the determination result of step S15 or S16 is abnormal, the work quality control system S outputs an abnormality notification from the notification unit 126a or 126b.

### Modification of Embodiment 1

In Embodiment 1, the microphone sensors 1031 and 1032 are built in the wearable sensor 103, but are not limited thereto, and may be provided at the work site.

The work quality control system S may not include the transmission unit 113 and the reception unit 121, and the signal processing unit 112 and the operation collation unit 122 may be directly connected. The database 125 can be omitted when the work state determination history, which is the determination result of step S15 or S16 of the work state determination processing of FIG. 9, is not stored.

When the work state determination processing of FIG. 9 is real-time processing, it is sufficient to notify the worker 100a of a work state determination result of step S15 or S16, and thus the notification unit 126b on the administrator 100b side may be omitted. In contrast, when the work state determination processing of FIG. 9 is offline processing, it is sufficient to notify the administrator 100b of the work state determination result of step S15 or S16, and thus the notification unit 126a on the worker 100a side may be omitted.

In Embodiment 1 described above, the resonant frequency peak derived from the resonant frequency sound is detected from the sensor signal based on the sound emitted from the instrument 101 due to the rotation of the motor of the instrument 101 detected by the microphone sensor 1031. Then, the operation period of the instrument 101 is recognized based on the resonant frequency peak. Then, by comparing the resonant frequency peak in the operation period of the instrument 101 with a normal value, it is determined whether the work using the instrument 101 is normal or abnormal.

Therefore, according to Embodiment 1, even in the work using the instrument 101 that does not have a function of directly detecting a physical quantity derived from the rotation of the motor, the abnormality detection of the work can be quantitatively performed.

### Embodiment 2

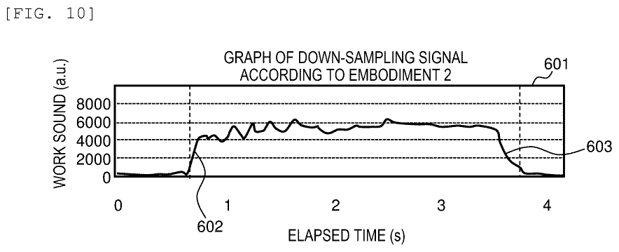

Embodiment 2 will be described with reference to the FIG. 10. Embodiment 2 will be described focusing on differences from Embodiment 1.

In Embodiment 2, compared to Embodiment 1, candidates are narrowed down by specifying an operation period of the instrument 101 by using a down-sampling signal obtained by down-sampling a sensor signal based on a sound acquired by the microphone sensor 1031. Then, an abnormality of a work state is detected based on a sensor signal corresponding to the candidate. Accordingly, calculation resources required to detect the abnormality of the work state are reduced, and the accuracy of abnormality detection is improved.

In Embodiment 1, the operation collation unit 122 extracts a characteristic sound (resonant frequency peak 302) of the instrument 101. To analyze sound, for example, a signal of 10 kHz requires data processing of million sampling points in 10 seconds, and thus a large amount of calculation resources are required in calculation with a large load such as Fourier transform.

Therefore, in Embodiment 2, data with a low sampling rate is used to reduce calculation resources.

In Embodiment 2, for example, as illustrated in FIG. 10, a down-sampling signal obtained by down-sampling the operation sound of the instrument 101 acquired by the microphone sensor 1031 may be used. FIG. 10 is a diagram illustrating an example of a graph 601 of the down-sampled down-sampling signal according to Embodiment 2.

The down-sampling may be, for example, maximum value pooling in which a recorded sound for a certain period of time is replaced with a maximum value or mean pooling in which the recording sound is replaced with a mean square. Alternatively, for example, the down-sampling may be decimation in which sound data of 10 kHz to 100 Hz is down-sampled.

In the work sound, as illustrated in the graph 601 of the down-sampling signal in FIG. 10, the sound continues to be continuously generated during the operation 44 the instrument 101. Accordingly, a start 602 and an end 603 of the work can be specified first. However, with a down-sampled sound of 100 Hz, it is difficult to distinguish between an actual work sound and other similar noise sounds.

Therefore, the operation collation unit 122 (FIG. 1) generates a down-sampling signal obtained by down-sampling the sensor signal that is the original sound, and narrows down candidates for the operation period of the instrument 101 by using the down-sampling signal. Thereafter, the signal determination unit 123 (FIG. 1) detects a resonant frequency peak from a sensor signal before down-sampling corresponding to the narrowed candidate, and determines whether the work state is normal or abnormal based on the detected resonant frequency peak.

By the processing, the calculation resources can be reduced as compared with a case in which all pieces of data before down-sampling are analyzed.

### Embodiment 3

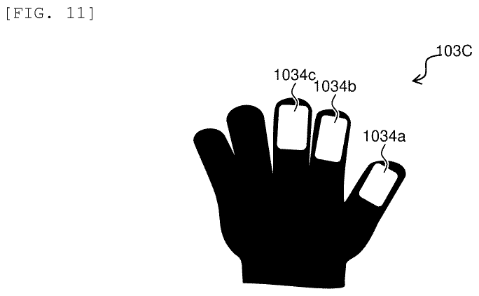

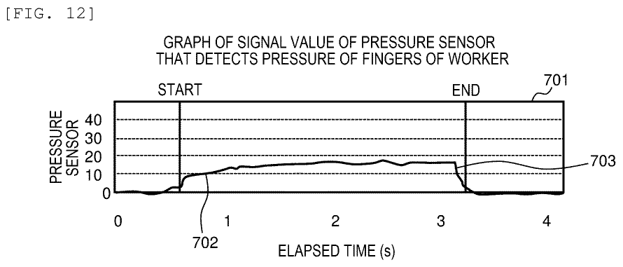

Embodiment 3 will be described with reference to FIGS. 11 and 12. Embodiment 3 will be described focusing on differences from Embodiment 2.

In Embodiment 2, data obtained by down-sampling the original sound is used as data with a low sampling rate used in the work quality control system S. However, the data with a low sampling rate may be data other than the sound data obtained by down-sampling the original sound, and for example, data from a pressure sensor may be used.

In Embodiment 3, when the worker 100a grips the instrument 101, a pressure applied to fingers caused by a vibration generated by rotation of a motor is monitored, and the start and the end of the work using the instrument 101 are specified using pressure data.

FIG. 11 is a diagram illustrating an example of a wearable sensor 103C according to Embodiment 3. The wearable sensor 103C includes built-in pressure sensors 1034a, 1034b, and 1034c in fingertips on a surface side in contact with the grip 1011b when the wearable sensor 103C is worn and the grip 1011b the electric screwdriver 1011a is gripped as illustrated in FIG. 4.

FIG. 12 is a diagram illustrating an example of a graph 701 of a signal value of a pressure sensor 1034 that detects the pressure of the fingers generated when the worker 100a grips the instrument 101. A sensor value indicated by the graph 701 in FIG. 12 is a representative value such as a total value, a mean value, or a maximum value of the sensor values of the pressure sensors 1034a, 1034b, and 1034c.

A grasping operation of a human finger does not require a sampling rate as high as that of sound data, and may be, for example, about 100 Hz. Therefore, similarly to the graph 601 (FIG. 10) according to Embodiment 2, the operation collation unit 122 (FIG. 1) first specifies a start 702 and an end 703 of the work as candidates from the graph 701. Thereafter, the signal determination unit 123 (FIG. 1) analyzes a work state by using the sensor signal corresponding to the narrowed candidate.

By the processing, as in Embodiment 2, required calculation resources can be reduced as compared with a case in which all pieces of data before down-sampling are analyzed.

When determining whether a period in which the pressure sensor 1034 does not respond is a determination target of the work state, on and off information of the switch 1011c may be used together when the switch 1011c is gripped with the fingers to start the work as in the electric screwdriver 1011a (FIG. 3). That is, only a period in which the pressure sensor 1034 does not respond and the switch 1011c is turned off is treated as a period excluded from the determination target of the work state. n this way, it is possible to reduce the probability of erroneously determining the period of the determination target as a period excluded from the determination target, and to improve the detection performance.

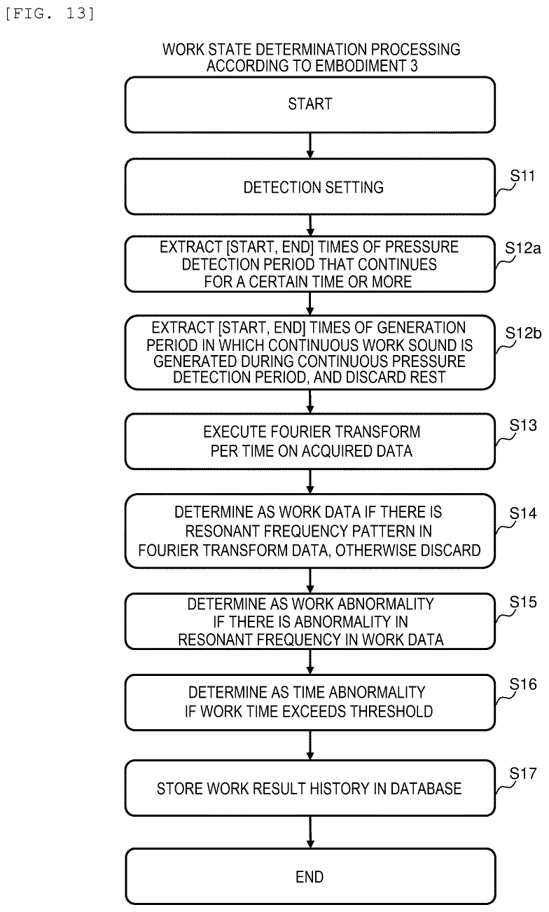

FIG. 13 is a flowchart illustrating work state determination processing according to Embodiment 3. The work state determination processing according to Embodiment 3 is Clean Copy of Substitute Specification different from the work state determination processing (FIG. 9) according to Embodiment 1 in that steps S12a and S12b are executed instead of step S12. Except for the difference, the work state determination processing according to Embodiment 3 is the same as the work state determination processing according to Embodiment 1.

In step S12a, the operation collation unit 122 (FIG. 1) extracts candidates for the start and end times of a pressure detection period that is detected by the pressure sensor 1034 and that continues for a certain time A or more. For example, the A is 0.5 seconds. Next, in step S12b, the operation collation unit 122 (FIG. 1) extracts start and end times of a generation period in which the continuous work sound is generated during the continuous pressure detection period extracted in step S12a from the data obtained by down-sampling the sensor signal of the original sound. In steps S12a and S12b, an operation signal indicating operations including the start and the end of the rotation of the internal rotation body of the instrument 101 performed by the worker 100a is specified.

In this way, by using a plurality of pieces of data with a low sampling rate as in steps S12a and S12b, it is possible to reduce calculation resources and improve detection accuracy.

An execution order of steps S12a and S12b may be changed. That is, candidates of the generation period in which the continuous work sound is generated may be extracted in step S12b, and the pressure detection period continuous for a certain time or more may be extracted from the candidates in step S12a. Even in this way, it is possible to specify the operation signal indicating the operations including the start and the end of the rotation of the internal rotation body of the instrument 101 performed by the worker 100a while achieving both the reduction of the calculation resources and the improvement of the detection accuracy.

### Other Examples of Data with Low Sampling Rate

The data with a low sampling rate may be, for example, data of an inertial sensor that detects a motion of the hand of the worker 100a. A signal transmitted from a work environment device during work may be used, and for example, information about a camera that captures images of the motion of the hand of the worker 100a may be used. The start and the end of the rotation of the rotation body can be detected more accurately based on operation information on the worker 100a.

### Embodiment 4

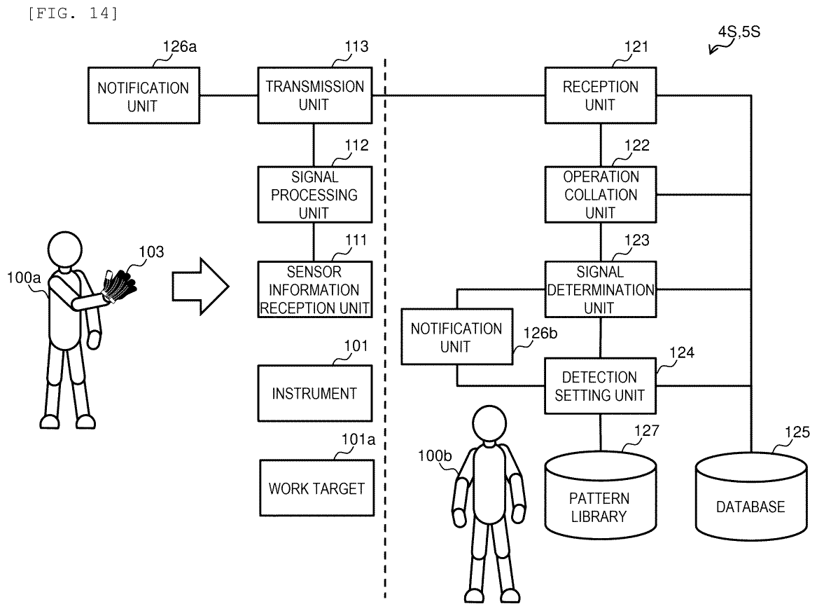

Embodiment 4 related to a detection setting will be described with reference to FIGS. 14 to 17. Embodiment 4 will be described focusing on differences from Embodiments 1 to 3.

The resonant frequency of the sound derived from the rotation body of the instrument 101 is determined not only by physical attributes of the instrument 101 such as the rotation speed and the shape of the internal rotation body but also by a plurality of conditions such as physical attributes of the work target 101a. Therefore, from the viewpoint of detection accuracy of the abnormality, it is desirable to prepare different detection patterns for each piece of work that is a combination of the instrument 101, the work target 101a, and the work content in advance, set the corresponding detection pattern, and perform the abnormality detection.

FIG. 14 is a diagram illustrating an example of a configuration of a work quality control system 4S according to Embodiment 4. The work quality control system 4S is different from the work quality control system S according to Embodiment 1 in that the work quality control system 4S includes a pattern library 126 that stores a plurality of detection patterns used when the detection setting unit 124 performs the abnormality detection. Other points are the same as those of the work quality control system S according to Embodiment 1. The work quality control system 4S can improve the detection accuracy by performing the abnormality detection of the work by switching the detection patterns for each combination of the instrument 101 and the work target 101a.

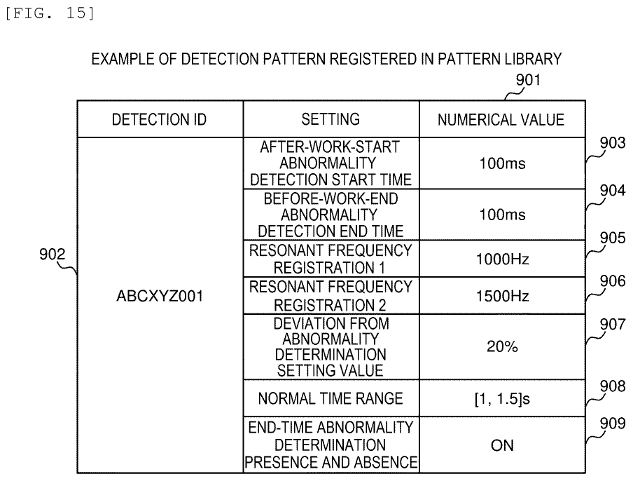

FIG. 15 is a diagram illustrating an example of a detection pattern 901 registered in the pattern library 126.

A detection ID 902 is an identifier of a plurality of the detection patterns 901. The detection ID 902 is provided for each piece of work.

An after-work-start abnormality detection start time 903 stores a time difference from a start time at which the abnormality detection is actually performed during the work time specified by the operation collation unit 122 (FIG. 14). Accordingly, an unstable signal due to slow rotation of the internal rotation body immediately after the start of the work is prevented from being detected as an abnormality.

A before-work-end abnormality detection end time 904 stores a time difference from an end time at which the abnormality detection is actually performed during the work time specified by the operation collation unit 122 (FIG. 14). Accordingly, an unstable signal due to a slow operation of the internal rotation body immediately before the end of the work is prevented from being detected as an abnormality.

Resonant frequency registrations 905 and 906 each store a resonant frequency to be detected in the work determination. The abnormality detection can be performed when the resonant frequencies matching the resonant frequency registrations 905 and 906 are included in the abnormality determination target data. The number of resonant frequencies that can be stored is not limited to two.

A deviation from abnormality determination setting value 907 stores a reference for the abnormality determination. The deviation from abnormality determination setting value 907 is a ratio (percentage or the like) or a difference of a deviation from the resonant frequency registrations 905 and 906 serving as a reference and is a predetermined value. When there is a deviation corresponding to the “deviation from abnormality determination setting value 907” as compared with the resonant frequency registrations 905 and 906 in the work data of the determination target, it is determined that there is an abnormality in the work.

A normal time range 908 stores a time that can be regarded as a normal work time. In the work data of the determination target, when an actual work time obtained by subtracting the after-work-start abnormality detection start time 903 and the before-work-end abnormality detection end time 904 is shorter or longer than the “normal time range 908” by a certain amount or more, it is determined that there is an abnormality in the work time.

In an end-time abnormality determination presence and absence 909, for example, a flag for determining whether to perform abnormality determination at the end illustrated in FIG. 8 is stored.

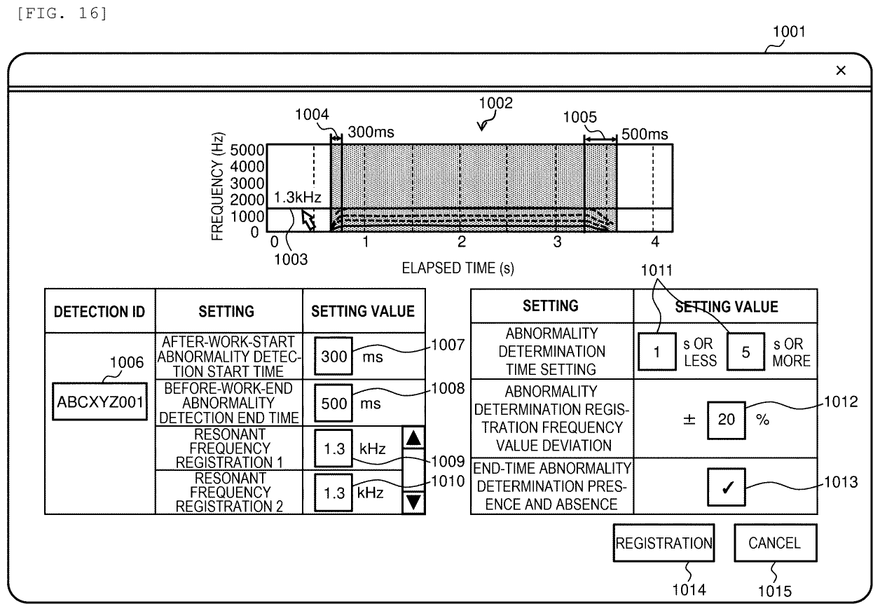

FIG. 16 is a diagram illustrating an example of a setting screen 1001 of the detection pattern 901 registered in the pattern library 127. The setting screen 1001 is executed by the detection setting unit 124 and displayed on a display screen of the notification unit 126b.

A detection ID 1006 is directly input or automatically input.

In an after-work-start abnormality detection start time 1007, a time 1004 may be adjusted by cursor movement in a graph display 1002 of the actually acquired work data, automatically displayed in the after-work-start abnormality detection start time 1007, and determined after confirmation. Similarly, in a before-work-end abnormality detection end time 1008, a time 1005 may be adjusted by cursor movement in the graph display 1002, automatically displayed in the before-work-end abnormality detection end time 1008, and determined after confirmation.

Similarly, in resonant frequency registration 1009, a frequency 1003 may be adjusted by cursor movement in the graph display 1002, automatically displayed in the resonant frequency registration 1009, and determined after confirmation. Resonant frequency registration 1010 is similar to the resonant frequency registration 1009.

Check boxes of an abnormality determination time setting 1011, an abnormality determination registration frequency value deviation 1012, and an end-time abnormality 1013 may be directly input to an input field.

When a registration button 1014 is pressed, a record of the detection pattern 901 reflecting each setting value displayed on the setting screen 1001 is created and stored in the pattern library 127. When a cancel button 1015 is pressed, the setting screen 1001 ends.

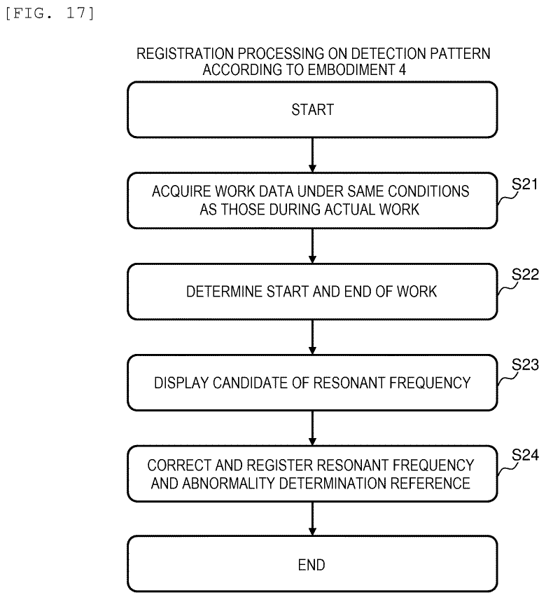

FIG. 17 is a flowchart illustrating registration processing on the detection pattern 901 in the pattern library 127 according to Embodiment 4. The registration processing on the detection pattern 901 in the pattern library 127 is activated by an instruction of the administrator 100b who manages the work quality by using the work quality control system 4S and is executed after setting the work quality control system 4S to a detection setting mode.

First, in step S21, the work quality control system 4S executes acquisition of work data under the same conditions as those during actual work. The acquisition of the work data under the same conditions as in the actual work refers to, for example, collecting a sound of the electric screwdriver 1011a of a determined model number when the electric screwdriver 1011a is used to perform screw tightening work in a determined location of the determined work target 101a with a screw of a determined model number.

Next, in step S22, similarly to step S12 (FIG. 9), the operation collation unit 122 extracts a start and an end of a sound having a resonant frequency.

Next, in step S23, the detection setting unit 124 extracts a candidate of the resonant frequency from the resonant frequency extracted in step S22 and displays the candidate of the resonant frequency on the setting screen 1001 on the notification unit 126b. The candidate of the resonant frequency extracted in step S23 may be one combination of the resonant frequency and a plurality of harmonics or may be a plurality of combinations of the resonant frequency and harmonics.

Next, in step S24, the detection setting unit 124 causes the administrator 100b to confirm and correct the resonant frequency displayed on the setting screen 1001 of the notification unit 126b and then registers the resonant frequency in the pattern library 127. That is, the detection setting unit 124 registers a setting value serving as a reference when the operation signal of the instrument 101 is specified. In step S24, the detection setting unit 124 further registers a setting value serving as a determination reference for normality and abnormality of the work of the worker 100a based on the operation sound of the instrument 101. In step S24, the candidate of the resonant frequency may not be automatically displayed on the setting screen 1001, and all pieces of data may be input by the administrator 100b in step S24.

In the work state determination processing (FIGS. 9 and 11) in Embodiment 4, in the detection setting in step S11, the detection pattern 901 corresponding to each work is read to execute the abnormality detection.

In Embodiment 4 described above, the detection pattern and the determination reference set from the setting screen 1001 based on the resonant frequency peak derived from the resonant frequency sound detected from the sensor signal under the same condition as the actual work are registered in the pattern library 127. Therefore, different detection patterns for each piece of work that is a combination of the instrument 101, the work target 101a, and the work content can be prepared in advance, the detection pattern corresponding to each piece of work can be set, and the abnormality detection can be executed.

### Modification of Embodiment 4

In the work using the instrument 101, a resonant frequency sound that is uniquely determined by the type of instrument and the environment of the work is generated. For example, when taking the work of the electric screwdriver 1011a as an example, an average work time for one time is determined by the work target and the work environment such as the rotation speed of the electric screwdriver 1011a and the length of the screw. Therefore, work step information and the detection pattern 901 are stored in the pattern library 127 in association with each other, and each time the work step is switched, the detection pattern 901 including the determination reference of the work abnormality corresponding to the work is switched and set in the operation collation unit 122 and the signal determination unit 123. Accordingly, it is possible to perform work abnormality detection for each work step.

That is, each time the start of the operation period of the instrument 101 is recognized, the detection pattern corresponding to the work is acquired from the pattern library 127 and set in the operation collation unit 122. Each time the start of the operation period of the instrument 101 is recognized, the determination reference of the work abnormality corresponding to the work is acquired from the pattern library 127 to set the signal determination unit 123.

When the electric screwdriver 1011a is taken as an example, the work performed by the worker 100a in one step is not limited to tightening a screw once, and there is a plurality of patterns such as tightening the same type or different types of screws a plurality of times or work other than the screw tightening. In response to such a case, the work step performed by the worker 100a and the work content in the work step may be associated with the detection pattern 901, and the detection pattern 901 corresponding to the work may be switched each time the work step is switched to perform the work abnormality detection.

### Embodiment 5

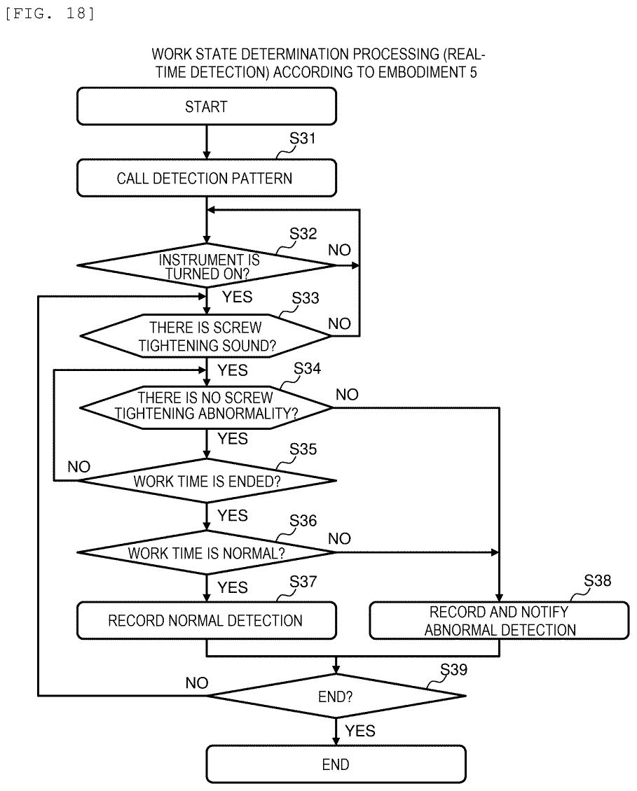

Embodiment 5 will be described with reference to the FIG. 18. Embodiment 5 will be described focusing on differences from Embodiments 1 to 4.

A work quality control system 5S according to Embodiment 5 notifies the worker 100a and the administrator 100b in real time when a work abnormality occurs. A configuration of the work quality control system 5S according to Embodiment 5 is the same as that of the work quality control system 4S (FIG. 14) according to Embodiment 4. In Embodiment 5, the worker 100a uses the wearable sensor 103C (FIG. 11) according to Embodiment 3.

FIG. 18 is a flowchart illustrating work state determination processing (real-time detection) according to Embodiment 5. The work state determination processing (real-time detection) according to Embodiment 5 is started before the work is started.

First, in step S31, the operation collation unit 122 calls the detection pattern 901 corresponding to an abnormality determination target work from the pattern library 127.

In the next steps S32 and S33, since the worker 100a has not necessarily started the work using the instrument 101, the work quality control system 5S performs processing to attempt to detect the corresponding work.

That is, in step S32, the operation collation unit 122 attempts to detect a change in the sensor value of the pressure sensor 1034 of the wearable sensor 103C when the worker 100a presses the switch 1011c (FIG. 3) of the instrument 101 with the hand. If the sensor value of the pressure sensor 1034 is equal to or larger than a predetermined value, the operation collation unit 122 determines that the instrument 101 is turned on (YES in step S32), shifts the processing to step S33, and performs the sound detection. On the other hand, if the sensor value of the pressure sensor 1034 is less than the predetermined value, the operation collation unit 122 determines that the instrument 101 is turned off (NO in step S32) and repeats step S32.

In step S33, the operation collation unit 122 attempts to detect a sound (for example, screw tightening sound) of a target work. The detection of the sound of the target work can be performed, for example, similarly to the work state determination processing (step S12 in FIG. 9, and steps S12a and S12b in FIG. 13). If the sound of the target work is detected (YES in step S33), the operation collation unit 122 shifts the processing to step S34, and if the sound of the target work is not detected (NO in step S33), the operation collation unit 122 returns the processing to step S32.

In step S34, the signal determination unit 123 determines whether there is an abnormality in the target work (for example, the screw tightening sound). The presence or absence of an abnormality in the target work can be determined, for example, in the same manner as the work state determination processing (steps S13 to S15 in FIGS. 9 and 13). If the signal determination unit 123 determines that there is no abnormality in the target work (for example, the screw tightening sound) (YES in step S34), the processing proceeds to step S35, and if the signal determination unit 123 determines that there is an abnormality within a certain time (NO in step S34), theprocessing proceeds to step S38.

In step S35, the signal determination unit 123 determines whether the target work is ended. The signal determination unit 123 shifts the processing to step S36 if the target work is ended (YES in step S35), and returns the processing to step S34 if the target work is not ended (NO in step S35).

In step S36, the signal determination unit 123 compares the detected work time with the normal time range 908 (FIG. 15) and determines whether the work time is normal. Step S36 is the same as the work state determination processing (step S16 in FIGS. 9 and 13). The signal determination unit 123 shifts the processing to step S37 if the work time is normal (YES in step S36), and shifts the processing to step S38 if the work time is abnormal (NO in step S36).

In step S37, the signal determination unit 123 records the normality detection and stores it in the database 125.

In contrast, in step S38, the signal determination unit 123 records the abnormality detection and stores it in the database 125, and notifies the worker 100a of the abnormality detection via the notification unit 126a and notifies the administrator 100b of the abnormality detection via the notification unit 126b. When step S37 or step S38 is ended, the work quality control system 5S shifts the processing to step S39.

In step S39, the work quality control system 5S determines whether to end the present work state determination processing (real-time detection). The work quality control system 5S ends the present work state determination processing (real-time detection) in the case of end (YES in step S39), and shifts the processing to step S33 in the case of not ending (NO in step S39).

In Embodiment 5, since the abnormality notification is performed in real-time when the worker 100a performs an abnormal operation, it is possible to prompt the worker 100a to pay attention to the abnormal work quickly.

### Other Embodiments

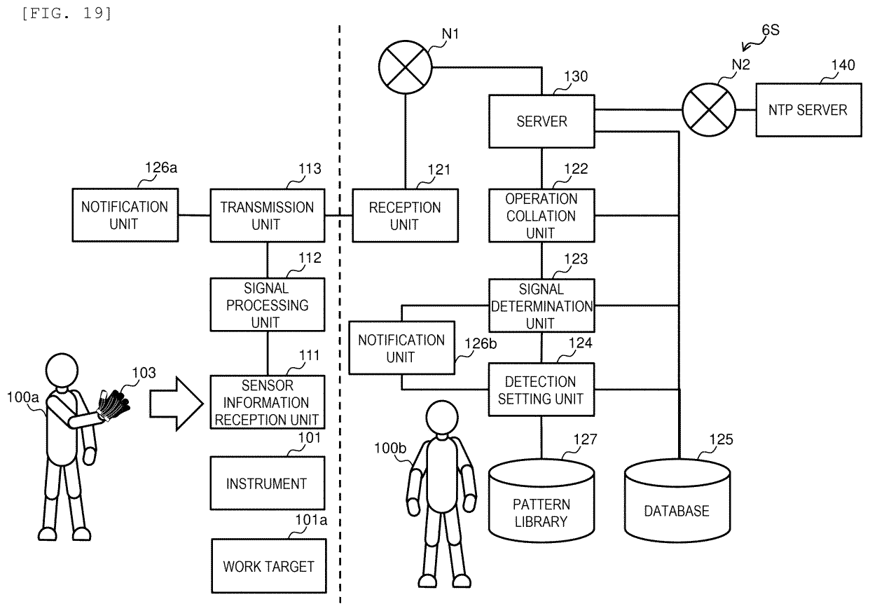

A configuration of the work quality control system is not limited to the system configurations of the work quality control system S (FIG. 1) according to Embodiment 1 and the work quality control system 4S (FIG. 14) according to Embodiment 4 described above. The work quality control systems S and 4S have a form in which the transmission unit 113 on the worker 100a side and the reception unit 121 on the administrator 100b side are connected via communication. However, as in a work quality control system 6S illustrated in FIG. 19, a server 130 serving as a gateway may be provided, and the reception unit 121 on the administrator 100b side may communicate with the server 130 via a network N1. The server 130 receives a sensor signal received by the reception unit 121 from the transmission unit 113 via the network N1 and outputs the sensor signal to the operation collation unit 122.

With such a configuration, the work quality control system 6S can provide a service of acquiring sensor information at, for example, a plurality of remote sites, intensively determining normality and abnormality of work on the server 130 side, and performing abnormality notification.

As illustrated in FIG. 19, the work quality control system 6S may use a standard time acquired from an NTP server 140 connected via a network N2. In this way, by storing and managing, based on the standard time, statistical data of abnormality analysis results based on the sensor information collected from the plurality of sites, it is possible to statistically manage the occurrence of the work failure in units of daily, monthly, or annual. In addition to the detection of normality and abnormality, a standard work time for each work can be calculated from the standard time.

The form obtained by omitting the configuration or processing or changing the processing order in each embodiment described above, or by adding the configuration or processing of one embodiment to the other embodiment is one of the other embodiments that are allowed as long as there is no contradiction.

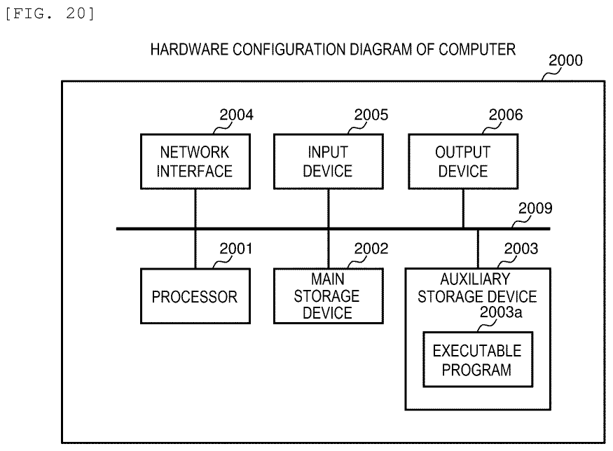

FIG. 20 is a diagram illustrating an example of a hardware structure of a computer 2000. The computer 2000 implements a work quality control device including at least the operation collation unit 122, the signal determination unit 123, the detection setting unit 124, the database 125, and the notification unit 126b (FIGS. 1, 14, and 19) by executing a predetermined program.

The computer 2000 includes a processor 2001 that is typically a CPU, a main storage device 2002, an auxiliary storage device 2003, a network interface 2004, an input device 2005, and an output device 2006, which are connected to one another via an internal communication line 2009 such as a bus.

The processor 2001 controls an overall operation of the computer 2000. The main storage device 2002 is implemented by, for example, a volatile semiconductor memory and is used as a work memory of the processor 2001. The auxiliary storage device 2003 includes a large-capacity nonvolatile storage device such as a hard disk device, a solid state drive (SSD), or a flash memory and is used to store various programs and data for a longtime.

An executable program 2100 stored in the auxiliary storage device 2003 is loaded onto the main storage device 2002 when the computer 2000 is activated or when necessary, and is executed by the processor 2001 such that each system that executes various types of processing is implemented.

The executable program 2100 may be recorded in a non-transitory recording medium, read from the non-transitory recording medium by a medium reading device, and loaded onto the main storage device 2002. Alternatively, the executable program 2100 may be acquired from an external computer via a network and loaded onto the main storage device 2002.

The network interface 2004 is an interface device for connecting the computer 2000 to a network in a system or communicating with other computers. The network interface 2004 includes, for example, a network interface card (NIC) such as a wired local area network (LAN) or a wireless LAN.

The input device 2005 includes a keyboard and a pointing device such as a mouse and is used by a user to input various instructions and information to the computer 2000. The output device 2006 includes, for example, a display device such as a liquid crystal display or an organic electro luminescence (EL) display, and an audio output device such as a speaker, and is used to present necessary information to the user when necessary.

Although the embodiments according to the invention are described in detail above, the invention is not limited to the embodiments described above, and various modifications can be made without departing from the gist thereof. For example, the embodiments described above are described in detail to facilitate understanding of the invention, and the invention is not necessarily limited to those including all the configurations described above. Another configuration can be added to, deleted from, or replaced with a part of a configuration of the embodiments described above.

A part or all of the configurations, functional units, processing units, processing methods, and the like according to the embodiments described above may be implemented by hardware by, for example, designing with an integrated circuit. The configurations, functions, and the like described above may be implemented by software by a processor interpreting and executing a program for implementing each function. Information such as a program, a table, and a file for implementing each function can be stored in a recording device such as a memory, a hard disk, and a solid state drive (SSD), or a recording medium such as an IC card, an SD card, and a DVD.

In the drawings according to the embodiments described above, control lines and information lines that are considered necessary for description are illustrated, and not all the control lines and information lines on implementation are necessarily illustrated. For example, it may be considered that almost all configurations are actually interconnected.

The work quality control systems S, 4S, 5S, and 6S, the functions of the work quality control device, and the arrangement form of each piece of data can be changed to an optimum arrangement form from the viewpoint of the performance of hardware and software, processing efficiency, communication efficiency, and the like. An execution order of the processing steps described in the embodiments described above can be changed as long as the processing results are the same.

In addition, the configuration (schema, and the like) of the database or the library that stores various pieces of data described above may be flexibly changed from the viewpoint of efficient use of resources, improvement in processing efficiency, improvement in access efficiency, improvement in search efficiency, and the like.

### REFERENCE SIGNS LIST

S, 4S, 5S, 6S: work quality control system
100b: administrator
101: instrument
101a: work target
103, 103C: wearable sensor
111: sensor information reception unit
112: signal processing unit
113: transmission unit
121: reception unit
122: operation collation unit
123: signal determination unit
124: detection setting unit
125: database
126a, 126b: notification unit
127: pattern library
2000: computer

1. A work quality control method executed by a work quality control system for managing work quality of a worker who performs work by rotation of a rotation body included in an instrument, the work quality control method comprising:
a signal processing step of digitizing a sound that is emitted from the instrument due to the rotation of the rotation body and that is detected by a microphone and generating a sensor signal;
a detection step of detecting a resonant frequency peak which is a peak of a frequency derived from a resonant frequency sound from a frequency distribution of the sensor signal;
an operation collation step of recognizing an operation period of the instrument based on a start and an end of a detection of the resonant frequency peak;
a signal determination step of determining normality or abnormality of the work based on the resonant frequency peak in the operation period recognized in the operation collation step; and
a notification step of notifying a determination result in the signal determination step.

2. The work quality control method according to claim 1, wherein
in the operation collation step, the resonant frequency peak is detected from a frequency spectrum of the sound, and the operation period is recognized by detecting a start and an end of the rotation of the rotation body based on the start and the end of the detection of resonant frequency peak.

3. The work quality control method according to claim 2, wherein
in the operation collation step, the resonant frequency peak is detected based on a resonant frequency of the resonant frequency sound.

4. The work quality control method according to claim 3, wherein
in the operation collation step, the operation period is recognized by detecting a start and an end of the rotation of the rotation body based on operation information on the worker and the start and the end of the detection of the resonant frequency peak.

5. The work quality control method according to claim 1, wherein
in the operation collation step, a down-sampling signal obtained by down-sampling the sensor signal is generated, and a candidate of the operation period of the instrument is extracted from the down-sampling signal, and
in the signal determination step, the resonant frequency peak derived from the resonant frequency sound is detected from the frequency distribution of the sensor signal before down-sampling corresponding to the candidate of the operation period extracted in the operation collation step.

6. The work quality control method according to claim 1, wherein
the microphone is provided in a glove to be worn on a hand of the worker who holds the instrument during the work.

7. The work quality control method according to claim 6, wherein
the glove includes a pressure sensor configured to detect a pressure when the worker wears the glove on the hand and grips the instrument, and
in the operation collation step, the operation period is recognized by detecting a start and an end of the rotation of the rotation body based on sensor information on the pressure sensor and the start and the end of detection of the resonant frequency peak.

8. The work quality control method according to claim 1, wherein
in the signal determination step, normality or abnormality of the work is determined based on a fluctuation of the resonant frequency peak from a normal value.

9. The work quality control method according to claim 1, wherein
in the signal determination step, normality or abnormality of the work is determined based on a length of the operation period.

10. The work quality control method according to claim 1, wherein
in the signal determination step, normality or abnormality of the work is determined based on a waveform of the resonant frequency peak at an end of the operation period.

11. The work quality control method according to claim 1, further comprising:
a detection setting step of setting a detection pattern to be collated when the resonant frequency peak is detected and setting a determination reference when determining normality or abnormality of the work based on the resonant frequency peak.

12. The work quality control method according to claim 11, further comprising:
a registration step of registering, in a library, the detection pattern and the determination reference which are set based on the resonant frequency peak derived from the resonant frequency sound detected from the sensor signal.

13. The work quality control method according to claim 12, wherein
in the detection setting step, each time a start of the operation period is recognized in the operation collation step, the detection pattern corresponding to the work is acquired from the library and set, and the determination reference corresponding to the work is acquired from the library and set.

14. A work quality control system for managing work quality of a worker who performs work by rotation of a rotation body included in an instrument, the work quality control system comprising:
a wearable sensor configured to be worn by the worker and including at least a microphone configured to detect a sound emitted from the instrument due to the rotation of the rotation body and a transmitter configured to transmit sensor information related to the sound detected by the microphone;
a sensor information reception unit configured to receive the sensor information;
a signal processing unit configured to digitize the sensor information and generate a sensor signal;
an operation collation unit configured to detect a resonant frequency peak which is a peak of a frequency derived from a resonant frequency sound from the sensor signal and recognize an operation period of the instrument based on the resonant frequency peak;
a signal determination unit configured to determine normality or abnormality of the work based on the resonant frequency peak in the operation period recognized by the operation collation unit; and
a notification unit configured to notify a determination result by the signal determination unit.

15. A work quality control device for managing work quality of a worker who performs work by rotation of a rotation body included in an instrument, the work quality control device comprising:
an operation collation unit configured to detect a resonant frequency peak which is a peak of a frequency_derived from a resonant frequency sound from a frequency distribution of a sensor signal obtained by digitizing a sound that is emitted from the instrument due to the rotation of the rotation body and that is detected by a microphone, and configured to recognize an operation period of the instrument based on a start and an end of a detection of the resonant frequency peak;
a signal determination unit configured to determine normality or abnormality of the work based on the resonant frequency peak in the operation period recognized by the operation collation unit; and
a notification unit configured to notify a determination result by the signal determination unit.
